(19) United States
(12) Patent Application Publication
(10) Pub. No.: US 2026/0010169 A1
(43) Pub. Date: Jan. 8, 2026

(54) PRECISION PATH PLANNING FOR AREA COVERAGE

(71) Applicant: Findklein GmbH, Zug (CH)

(72) Inventor: Mogens Max Sophus Edzard PLESSEN, Zug (CH)

(73) Assignee: Findklein GmbH, Zug (CH)

(21) Appl. No.: 19/261,434

(22) Filed: Jul. 7, 2025

Related U.S. Application Data
(63) Continuation of application No. PCT/EP2024/069214, filed on Jul. 8, 2024.

(51) Int. Cl. G05D 1/644; A01B 69/04; G05D 107/20

(52) U.S. Cl. CPC G05D 1/6445; A01B 69/008; G05D 2107/21

(57) ABSTRACT

A method for automatically path planning for optimizing a path of a machinery moving in an area, comprises the steps of: taking coordinates of an area contour, a working width of the machinery operating in the area, a mathematical description of the dynamics of the machinery operating in the area in form of a system of nonlinear differential equations, determines segments along the headland path which are not feasible with respect to dynamics of the machinery or whose traversal would result in area coverage gaps. A mathematical algorithm is used with a hierarchical two-step framework in combination with a special coordinate transformation from a time into a spatial domain to formulate geographic high-precision constraints. The hierarchical two-step framework addresses two objectives: a generation of headland paths and a generation of smooth transitions between headland path and mainfield lanes, whereby the first hierarchical step varies for the two objectives.

### CROSS REFERENCE TO RELATED APPLICATIONS

This application is a Rule 53(b) Continuation of International Application No. PCT/EP2024/069214 filed on Jul. 8, 2024, the respective disclosures of all of the above of which are incorporated herein by reference in their entirety.

### TECHNICAL FIELD

The present invention relates to a method for automatically path planning for optimizing a path of a machinery moving in an area as well as a first software product for performing this method, a second software product using data obtained by this method and a device for performing the method. The invention is especially useful for agriculture, especially open-space agriculture.

### BACKGROUND OF THE INVENTION

Path plans have to be devised for the coverage of an agricultural field or agriculturally used work area. Machinery tracking the path plans can be robots or vehicles, such as tractors and harvesters, but also airplanes, helicopters, unmanned aerial vehicles and the like. Dynamics of these machineries can mathematically be expressed in form of a system of nonlinear differential equations.

Path plans enable a cost-efficient and/or a time-efficient optimized path through agricultural fields. Time is important, in particular during grain harvesting due to changing weather conditions and the subsequent availability of only a limited number of harvesting hours. Energy (typically Diesel) savings and likewise the reduction of operating hours and wear of the machinery are of interest not only for cost reduction, but for environmental reasons and regulatory exhaust emission standards.

A typical agricultural field is characterized by being a usually arbitrarily and non-convexly shaped closed area with potentially sloped terrain, in general arbitrarily shaped contour boundary, and obstacle areas such as trees, stones, ponds, power pole masts or similar closed “island areas” not suited for planting and prohibited from traversal by the machinery.

Underlying objectives for determining path plans for machinery, especially for large machinery, are (i) area coverage gap avoidance such that the entire work area is covered, (ii) feasibility of the path plan with respect to dynamics of the machinery, and (iii) optimization according to a criterion such as, for example, minimization of the pathlength or minimization of the number of headland turns.

The computational complexity for calculating such path plans can be demanding, especially for larger fields.

Methods that frequently are used for the computation of paths between two coordinates and heading directions are so-called Dubins paths (see Dubins, Lester E. “On curves of minimal length with a constraint on average curvature, and with prescribed initial and terminal positions and tangents.” American Journal of mathematics 79.3 (1957): 497-516) and Reeds-Shepp paths (see Reeds, James, and Lawrence Shepp. “Optimal paths for a car that goes both forwards and backwards.” Pacific journal of mathematics 145.2 (1990): 367-393).

Dubins paths can provide the shortest path between two coordinates and heading directions for a forward-moving vehicle with a specific turning radius. However, a Dubins path, which is composed entirely of no more than three circular arcs of minimum turning radius or straight lines, is derived based on a simplified mathematical model of a vehicle that in general does not represent the actual dynamics of the machinery operating in an agricultural field. A second disadvantage is that Dubins path are always only composed of straight lines and arcs of minimum turning radius, i.e., straights and maximum steering turns. For refining of path segments and generation of path segments that do not require maximum steering but instead demand focus on other constraints, such as area coverage gap avoidance, Dubins path planning is not sufficient.

A Reeds-Shepp path differs from a Dubins path in that travel in the reverse direction is also allowed. While for a Dubins path only forward-motion applies, a Reeds-Shepp path permits combinations of forward- and backward-motion. Thus, Reeds-Shepp paths are a generalization of Dubins paths. For Reeds-Shepp paths the same aforementioned issues as for Dubins paths apply.

The following notation is used in this text. A physical area, such as an agricultural field or an agriculturally used work area, is mathematically defined by the difference (mathematical set operation) between (i) an ordered set of geographic coordinates that describe a physical area contour as a (in general non-convexly shaped) polygon, and (ii) polygons defined by ordered sets of geographic coordinates that describe the contours of any physical obstacle areas (tree islands, ponds, power pole masts, and so forth) that are not to be passed by the moving machinery within the physical field area contour. By copying the mathematically defined work area-contour and applying an erosion operation (mathematical morphological operation), an eroded working area smaller than the working area and a corresponding eroded working area contour are obtained.

The eroded working area contour is herein called headland path. The mathematical erosion operation can be conducted multiple times to generate multiple headland paths. The eroded working area is herein called headland area. The eroded working area bounded by the innermost headland path is herein called mainfield area.

WO 2017/092904 A1 discloses such a method for planning a path of a machinery moving in an area. The method considers a working width of a moving machinery. The area is eroded (mathematical morphological operation) and the eroded area is partitioned into interior lanes. The interior lanes are intersected with a contour of the eroded area, thereby generating a lane grid. A mathematical algorithm is performed for determining an optimized sequence of position coordinates on the lane grid, wherein an area covering path is generated. This method enables to find an optimized path considering obstacles such as tree islands within the area. The content of this publication is entered to this text by reference.

The headland area is typically used for turning and usually planted in another direction than the mainfield area. By partitioning the eroded working area into adjacent lanes, which shall in the following be denoted as mainfield lanes, selecting an orientation of the lanes and by intersecting the mainfield lanes with the eroded area contour, a lane-grid and a corresponding connected undirected transition graph of the area is generated. Instead of straight mainfield lanes also freeform mainfield lanes, in shape similar to a path segment of the eroded area contour, can be fitted and propagated by an offset distance (the working width) to cover the eroded word area. Based on the lane-grid a path plan for field coverage can be determined. Such a path plan, in general, does (i) not yet guarantee feasibility with respect to dynamics of the machinery, and (ii) does not yet guarantee area coverage gap avoidance.

### SUMMARY OF THE INVENTION

It is therefore an object of the invention to provide path planning which improves feasibility with respect to dynamics of a machinery and minimizes area coverage gaps.

The inventive methods use a transformation from a time domain into a spatial domain. This enables an efficient and precise path planning for big machinery, especially for agricultural machinery. By using the inventive method, the machinery can even pass difficult shapes of headlands and obstacles within the area without or with a minimum of area coverage gaps.

The invention enables precision path planning for machinery moving in an area to account for detailed dynamics of the machinery given in form of a system of nonlinear differential equations and to minimize or avoid area coverage gaps.

The expressions “avoid” or “avoidance” or similar expressions using “avoid” are understood in this text as complete avoidance or best possible minimization.

A first inventive method generates one or multiple precision headland paths, herein called first application. A second inventive method generates precision transitions, especially between headland path and mainfield lanes, between mainfield lanes and headland, and between pairs of mainfield lanes, herein called second application. The first and second methods are preferably combined, wherein they are preferably embedded withing an optimization loop and repeated iteratively to achieve a high-level optimization.

Within this invention, both applications are addressed by the same high-level approach comprised of two hierarchical steps:
First, a first path modification, which differs for the two applications.
Second, a second path modification, which applies the same mathematical method for the two applications using a special coordinate transformation from a time domain into a spatial domain, i.e. from a time-based coordinate system into a spatial-based coordinate system.

A spatial-based coordinate system may imply expressing the dynamics of a machinery with respect to at least one of a path progress along a first resulting path, a pathlength along a first resulting path, or an arc length along a first resulting path. A time-based coordinate system may imply expressing the dynamics of a machinery with respect to a point in time along the time axis.

The first path modification for the first application comprises the steps of
(i) taking as input a headland path generated by an erosion operation (mathematical morphological operation) for a working width,
(ii) determining segments along the headland path which are not feasible to be traversed due to the dynamics of the machinery or whose traversal would result in area coverage gaps for the working width of the machinery, and
(iii) modifying spatial waypoint coordinates along the segments in a manner, for example by constructing a piecewise affine or polynomial envelope function (mathematical bounding function), such that the area coverage gaps are corrected, i.e. minimized or avoided.

The modifications in general do not yet guarantee feasibility of the resulting path with respect to dynamics of the machinery, i.e., there is no guarantee that the segments can actually be traversed, for example, by an autonomous tractor. Feasibility is addressed in the second hierarchical step which is described in more detail further below.

The first path modification for the second application comprises the steps of
(i) taking as input a path plan for area coverage given by a sequence of position coordinates,
(ii) determining segments along the path plan for area coverage which are not feasible with respect to dynamics of the machinery or whose traversal would result in area coverage gaps, specifically, at transitions between headland path and mainfield lanes, between mainfield lanes and headland path, and between pairs of mainfield lanes,
(iii) modifying spatial waypoint coordinates along the transitions through their replacement with a suitably fitted (e.g., minimally deviating from the original transition) Dubins and Reeds-Shepp path segments and heuristics (such as selection of interpolation and discretization spacing or consisting of selection of interpolation and discretization spacing).

“Heuristics” means “arriving at a solution by trying different actions to see if they produce the result that is wanted”. Heuristics are in general used to ‘shape the solution’ to a desired form.

The heuristics mentioned in this text and especially above in (iii) can be understood as one or all of the following:
“ . . . by heuristics in order to reshape each of the first segments such that the area coverage gaps are minimized, but a resulting path is not yet feasible with respect to dynamics of the machinery”,
“ . . . by heuristics in order to reshape each of the first segments with piecewise-affine path segments such that the area coverage gaps are minimized, but a resulting path is not yet feasible with respect to dynamics of the machinery”
“ . . . by heuristics such as replacing each of the first segments with piecewise-affine path segments such that the area coverage gaps are minimized, but a resulting path is not yet feasible with respect to dynamics of the machinery”
“ . . . by heuristics such as replacing each of the first segments with new path segments such that the area coverage gaps are minimized, but a resulting path is not yet feasible with respect to dynamics of the machinery”
“heuristics are used in a creation of a first modification by modifying spatial waypoint coordinates along each of the first segments in order to reshape each of the first segments such that the area coverage gaps are minimized, but a resulting path is not yet feasible with respect to dynamics of the machinery”
“heuristics are used in a creation of a first modification by modifying spatial waypoint coordinates along each of the first segments in order to reshape each of the first segments with piecewise-affine path segments such that the area coverage gaps are minimized, but a resulting path is not yet feasible with respect to dynamics of the machinery”
“heuristics are used in a creation of a first modification by modifying spatial waypoint coordinates along each of the first segments such as replacing each of the first segments with piecewise-affine path segments such that the area coverage gaps are minimized, but a resulting path is not yet feasible with respect to dynamics of the machinery”
“heuristics are used in a creation of a first modification by modifying spatial waypoint coordinates along each of the first segments such as replacing each of the first segments with new path segments such that the area coverage gaps are minimized, but a resulting path is not yet feasible with respect to dynamics of the machinery”.

The modifications in general do not yet guarantee feasibility of the resulting path with respect to dynamics of the machinery since Dubins and Reeds-Shepp paths are derived from simplified vehicle dynamics that in general may not represent the actual dynamics of the machinery. Feasibility is addressed in the second hierarchical step which is described next.

For the second path modification the same mathematical method is applied for both aforementioned applications. Inputs are path segments resulting from the first path modification and a mathematical description of dynamics of the machinery in form of a system of nonlinear differential equations. Then, in order to generate the second path modification such that the resulting path becomes feasible with respect to dynamics of the machinery, the following method is suggested.

First, apply a transformation of the dynamics of the machinery from a time domain into a spatial domain. This implies replacing a time coordinate with a spatial coordinate along a path as the dependent variable and transforming the differential equations for the dynamics of the machinery from a time domain into a spatial domain. The transformation entails introducing a new set of variables describing the dynamics of the machinery in a path-aligned coordinate system instead of a global coordinate system with latitude and longitude (or their equivalent in the Universal Transverse Mercator (UTM) coordinate system in order to calculate in metric units) describing position coordinates.

By replacing time as a dependent variable, a new set of variables can be introduced in a path-aligned coordinate system. An alternative system of nonlinear differential equations may be generated, and a new set of variables may be introduced in a path-aligned coordinate system. An alternative system of nonlinear differential equations may be generated with differentiation with respect to the spatial coordinate instead of with respect to time and a new set of variables may be introduced in a path-aligned coordinate system.

Second, within this new coordinate system formulate an optimization problem, preferably a convex optimization problem, subject to constraints, preferably constraints that enforce the path to avoid any area coverage gaps. The fact that these constraints are formulated in the spatial domain permits high precision results and permits to solve both of the two applications
(i) with respect to feasibility of dynamics of the machinery and
(ii) for area coverage gap avoidance.

### The Invention Uses

(i) a coordinate transformation as a prerequisite for the formulation of suitable optimization problems and
(ii) embeds the coordinate transformation within a hierarchical framework that can address both applications,
   wherein the first preparatory step varies for the two applications.

In detail, a first inventive computer-implemented method for automatically path planning for optimizing a path of a machinery moving in an area, the method comprising the steps of
considering at least the following parameters:
   coordinates of an area contour of the area in a global coordinate system,
   a working width of the machinery operating in the area,
   a mathematical description of dynamics of the machinery operating in the area in form of a system of nonlinear differential equations,
making a copy of the area contour and geometrically translating this copy in parallel by a fraction of the working width to an interior of the area, thereby obtaining an eroded area being smaller or equal than the area and an eroded area contour of the eroded area, the eroded area contour being denoted as a headland path,
determining first segments along the headland path which are not feasible to be traversed by the machinery due to the dynamics of the machinery or whose traversal would result in area coverage gaps for the working width of the machinery,
modifying the first segments such that their traversals become feasible with respect to dynamics of the machinery and such that their traversals minimize area coverage gaps, thereby using a first mathematical algorithm,
wherein the first mathematical algorithm comprises two hierarchical steps for handling each of the first segments,
   (i) first, creating a first modification by modifying spatial waypoint coordinates along each of the first segments by heuristics such that the area coverage gaps are corrected, i.e. minimized or avoided, but a first resulting path is not yet feasible with respect to dynamics of the machinery,
   (ii) second, creating a second modification by applying a transformation of the system of nonlinear differential equations describing the dynamics of the machinery from a time domain into a spatial domain with space along the first resulting path of step (i) replacing time as a dependent variable in the system of nonlinear differential equations and introducing a new set of variables in a path-aligned coordinate system instead of the global coordinate system, formulating a first mathematical optimization problem with a set of inequality constraints based on the path resulting from the previous step (i) such that the area coverage gaps are minimized or avoided, and with a set of equality constraints such that feasibility of a second resulting path with respect to the dynamics of the machinery is addressed, solving the first mathematical optimization problem and transforming a solution of the first mathematical optimization problem from the path-aligned coordinate system back to the global coordinate system, such that after the modification of all the first segments a modified headland path is generated that is feasible with respect to dynamics of the machinery and minimizes area coverage gaps.

The second resulting path is therefore made feasible with respect to the dynamics of the machinery. It can be followed by the machinery.

Preferably, the method comprises the further steps of
selecting an orientation of straight lanes or a shape of freeform lanes within the area bounded by the modified headland path and thereby partitioning the eroded area into adjacent mainfield lanes,
intersecting the mainfield lanes with the modified headland path, thereby generating a lane-grid,
determining a sequence of the traversal of the mainfield lanes for area coverage, thereby generating a path plan for area coverage given by a sequence of position coordinates,
determining second segments along the path plan for area coverage which are not feasible to be traversed by the machinery due to the dynamics of the machinery or whose traversal would result in area coverage gaps, specifically, at transitions between headland path and mainfield lanes, between mainfield lanes and headland path, and between pairs of mainfield lanes,
modifying the second segments such that their traversals become feasible with respect to dynamics of the machinery and such that their traversals minimize area coverage gaps, thereby using a second mathematical algorithm,
wherein the second mathematical algorithm comprises two hierarchical steps for handling of each of the second segments,
   (i) first, creating a first modification by modifying spatial waypoint coordinates along each of the second segments through their replacement with a suitably fitted path segment, preferably a Dubins or Reeds-Shepp path segment, such that the second resulting path is smoothed but in general not yet feasible with respect to dynamics of the machinery,
   (ii) second, creating a second modification by applying a transformation of the system of nonlinear differential equations describing the dynamics of the machinery from a time domain into a spatial domain with space along the second resulting path of step (i) replacing time as a dependent variable in the system of nonlinear differential equations and introducing a new set of variables in a path-aligned coordinate system instead of the global coordinate system, formulating a second mathematical optimization problem with a set of inequality constraints based on the path resulting from the previous step (i) such that area coverage gaps are avoided, and with a set of equality constraints such that feasibility of a second resulting path with respect to the dynamics of the machinery is addressed, solving the second mathematical optimization problem and transforming a solution of the second mathematical optimization problem from the path-aligned coordinate system back to the global coordinate system, such that after the modification of all the second segments a modified path plan for area coverage is generated that is feasible with respect to dynamics of the machinery and minimizes area coverage gaps.

Preferably, a first cascade of headland paths are generated by an erosion operation (mathematical morphological operation) for a given working width and a given contour of the field area, wherein the first mathematical algorithm is iteratively applied to each of the first cascade of headland paths thereby generating multiple modified headland paths each being feasible with respect to dynamics of the machinery and minimizing area coverage gaps.

Preferably, the first headland path is generated before more headland paths are generated. The more headland paths are each generated by an erosion operation for a given working width and the last previously generated headland path. Then, the first mathematical algorithm is iteratively applied to each of the generated headland paths thereby generating multiple modified headland paths each being feasible with respect to dynamics of the machinery and minimizing area coverage gaps.

Preferably, the considered parameters additionally include coordinates of a contour of any obstacle being present within the area, wherein the obstacle is not to be passed by the moving machinery, and wherein the method comprises the further steps of:
making a copy of the contour of any obstacle and geometrically translating this copy in parallel by a fraction of the working width away from the obstacle interior, thereby obtaining a corrected eroded area and an eroded obstacle contour of any obstacle being present within the area and
performing the first mathematical algorithm for each of the eroded obstacle contours, thereby generating an obstacle headland path for each obstacle being present within the area and the path being feasible with respect to dynamics of the machinery and minimizing area coverage gaps.

Preferably, a second cascade of headland paths are generated by an erosion operation for a given working width and a given contour of any obstacle present within the field area and wherein the first mathematical algorithm is iteratively applied to each of the second cascade of headland paths, thereby generating multiple obstacle headland paths each being feasible with respect to dynamics of the machinery and minimizing area coverage gaps.

Preferably, the second headland path is generated by an erosion operation for a given working width and a given contour of any obstacle present within the field area before more headland paths are generated. The more headland paths are each generated by an erosion operation for a given working width and the last previously generated headland path. Then, the first mathematical algorithm is iteratively applied to each of the second headland paths thereby generating multiple obstacle headland paths, each being feasible with respect to dynamics of the machinery and minimizing area coverage gaps.

Preferably, the method comprises the step of determining a sequence of mainfield lanes to generate a path plan for area coverage whose traversal does not yet account for feasibility with respect to the dynamics of the machinery and for area coverage gap avoidance, and performing the method within a global optimization scheme,
thereby generating an optimal path plan for area coverage that is feasible with respect to dynamics of the machinery, minimizing area coverage gaps and is optimized according to one of the criteria of: minimization of total field coverage pathlength, minimization of accumulated length of mainfield lanes, minimization of accumulated turning for field coverage, minimization of accumulated turning when traversing between mainfield lanes and headland path, minimization of maximal turning when traversing between mainfield lanes and headland path, minimization of accumulated absolute vehicle roll angles above a user-defined threshold resulting from field slopes in hilly terrain along mainfield lanes, minimization of maximal absolute vehicle roll angles resulting from field slopes in hilly terrain along mainfield lanes, avoidance of absolute vehicle roll angles above a user-defined threshold resulting from field slopes in hilly terrain, connections to roads and logistical harvesting organization, minimization of completion time for field coverage, as well as a weighted trade-off between at least some of the aforementioned criteria.

Preferably the method provides as output at least a sequence of position coordinates, the sequence giving a path to be followed by the machinery.

An inventive first software program product for performing the inventive method comprises an algorithm for computing a path plan feasible with respect to dynamics of the machinery and minimizing area coverage gaps.

An inventive second software program product comprising stored data identifying a path based on position coordinates of a machinery according to the inventive method gives guidance to the machinery and/or a user of the machinery in order to enable the machinery to follow the path by usage of information of at least one location sensor, preferably to enable path tracking of the machinery.

The stored data are stored in storing means, preferably in a database.

Especially in automated path tracking, a location of the machinery is preferably tracked. One means to enable such a tracking is at least one location sensor. Preferably, the location sensor is fixed to or implemented in the machinery. Preferably, the location sensor is a satellite-based navigation device such as a GPS receiver (GPS=Global Positioning System), which signals may be corrected for improved location accuracy (Differential GPS, RTK=Real Time Kinematic satellite navigation and the like). Alternatively, location sensors include lasers and optics as positioning technologies. In the following, devices capable of determining a position with respect to a particular coordinate system in the term “location sensor” are summarized. However, other devices may be used as location sensors in the sense of this invention as well.

The execution of following a precomputed path can be aided in three major ways: fully autonomous steering, semi-autonomous steering and human operator manual steering with visual and audio support in form of, e.g., mobile tablets, smartphones and displays. A location sensor is commonly employed. Usually satellite-based navigation devices such as GPS receivers (GPS=Global Positioning System) are employed, whose signals may be corrected for improved location accuracy (Differential GPS, RTK=Real Time Kinematic satellite navigation and the like).

An inventive device for performing the inventive method comprises input means for providing parameters, means for reading of geographic location measurements returned from a location sensor and for choosing heuristics and wherein the device comprises
display means for displaying data enabling a machinery and/or a user of the machinery to follow a path and/or
output means for delivering data enabling the machinery and/or the user of the machinery to follow the path.

The means for reading geographic location measurements are preferably returned from a location sensor to enable path tracking of the machinery.

A second inventive computer-implemented method for automatically path planning for optimizing a path of a machinery moving in an area, the method comprising the steps of
considering at least the following parameters:
   coordinates of an area contour of the area in a global coordinate system,
   a working width of the machinery operating in the area,
   a mathematical description of dynamics of the machinery operating in the area in form of a system of nonlinear differential equations,
making a copy of the area contour and geometrically translating this copy in parallel by a fraction of the working width to an interior of the area, thereby obtaining an eroded area being smaller or equal than the area and an eroded area contour of the eroded area, the eroded area contour being denoted as a headland path,
selecting an orientation of straight lanes or a shape of freeform lanes within the area bounded by the modified headland path and thereby partitioning the eroded area into adjacent mainfield lanes,
intersecting the mainfield lanes with the headland path, thereby generating a lane-grid,
determining a sequence for the traversal of the mainfield lanes for area coverage, thereby generating a path plan for area coverage given by a sequence of position coordinates,
determining second segments along the path plan for area coverage which are not feasible to be traversed by the machinery due to the dynamics of the machinery or whose traversal would result in area coverage gaps, specifically, at transitions between headland path and mainfield lanes, between mainfield lanes and headland path, and between pairs of mainfield lanes,
modifying the second segments such that their traversals become feasible with respect to dynamics of the machinery and such that their traversals minimize area coverage gaps, thereby using a second mathematical algorithm,
wherein the second mathematical algorithm comprises two hierarchical steps for handling of each of the second segments,
   (i) first, creating a first modification by modifying spatial waypoint coordinates along each of the second segments through their replacement with a suitably fitted path segment, preferably a Dubins or Reeds-Shepp path segment, such that the second resulting path is smoothed but in general not yet feasible with respect to dynamics of the machinery,
   (ii) second, creating a second modification by applying a transformation of the system of nonlinear differential equations describing the dynamics of the machinery from a time domain into a spatial domain with space along the second resulting path of step (i) replacing time as a dependent variable in the system of nonlinear differential equations and introducing a new set of variables in a path-aligned coordinate system instead of the global coordinate system, formulating a second mathematical optimization problem with a set of inequality constraints based on the path resulting from the previous step (i) such that area coverage gaps are avoided, and with a set of equality constraints such that feasibility of a second resulting path with respect to the dynamics of the machinery is addressed, solving the second mathematical optimization problem and transforming a solution of the second mathematical optimization problem from the path-aligned coordinate system back to the global coordinate system, such that after the modification of all the second segments a modified path plan for area coverage is generated that is feasible with respect to dynamics of the machinery and minimizes area coverage gaps.

The features of the inventive methods and the software and devices mentioned above can also be combined with the above-mentioned second method without using all the steps of the above-mentioned first inventive method.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 is a block diagram for the flow of actions from data input comprising field and obstacle area contour coordinates, to offline computation generating an optimized field coverage path plan feasible with respect to dynamics of the machinery and minimizing area coverage gaps, to online tracking of the complete field coverage path plan according to the invention;

FIG. 2 is an exemplary agricultural field to illustrate data input comprising field and obstacle area contour coordinates;

FIG. 3 shows for an exemplary agricultural field three exemplary headland paths generated when accounting for feasibility with respect to dynamics of the machinery and seeking area coverage gap avoidance;

FIG. 4 illustrates for an exemplary agricultural field an area coverage gap, a headland path and transitions between mainfield lanes and headland path not feasible with respect to dynamics of the machinery of typical nonholonomic (mathematical system characteristics) vehicles with a limited turning radius;

FIG. 5 illustrates for an exemplary agricultural field a modified headland path feasible with respect to typical dynamics of the machinery and resulting in area coverage gap avoidance, and transitions between mainfield lanes and headland path not yet modified and feasible with respect to typical dynamics of the machinery;

FIG. 6 illustrates for an exemplary agricultural field and a smaller turning radius in comparison to the working width transitions between mainfield lanes and headland path when accounting for dynamics of the machinery and seeking area coverage gap avoidance;

FIG. 7 illustrates for an exemplary agricultural field and a larger turning radius in comparison to the working width transitions between mainfield lanes and headland path when accounting for dynamics of the machinery and seeking area coverage gap avoidance;

FIG. 8 illustrates for an exemplary agricultural field transitions between headland path and mainfield lanes that are not feasible with respect to typical dynamics of the machinery;

FIG. 9 illustrates for an exemplary agricultural field and a smaller turning radius in comparison to the working width transitions between mainfield lanes and headland path when accounting for dynamics of the machinery and seeking area coverage gap avoidance;

FIG. 10 illustrates for an exemplary agricultural field and a larger turning radius in comparison to the working width transitions between mainfield lanes and headland path when accounting for dynamics of the machinery and seeking area coverage gap avoidance;

FIG. 11 illustrates for an exemplary agricultural field transitions between headland path and mainfield lanes that are not feasible with respect to typical dynamics of the machinery;

FIG. 12 illustrates for an exemplary agricultural field and a larger turning radius in comparison to the working width transitions between mainfield lanes when accounting for dynamics of the machinery and seeking area coverage gap avoidance;

FIG. 13 illustrates for an exemplary agricultural field a path involving both forward and backward motion, that is typical for Reeds-Shepp path planning, along the headland path;

FIG. 14 illustrates for an exemplary agricultural field the transition along a headland path when accounting for dynamics of the machinery, specifically targeting area coverage gap avoidance, and specifically desiring forward motion only in order to save pathlength and minimize tractor traces in the work area.

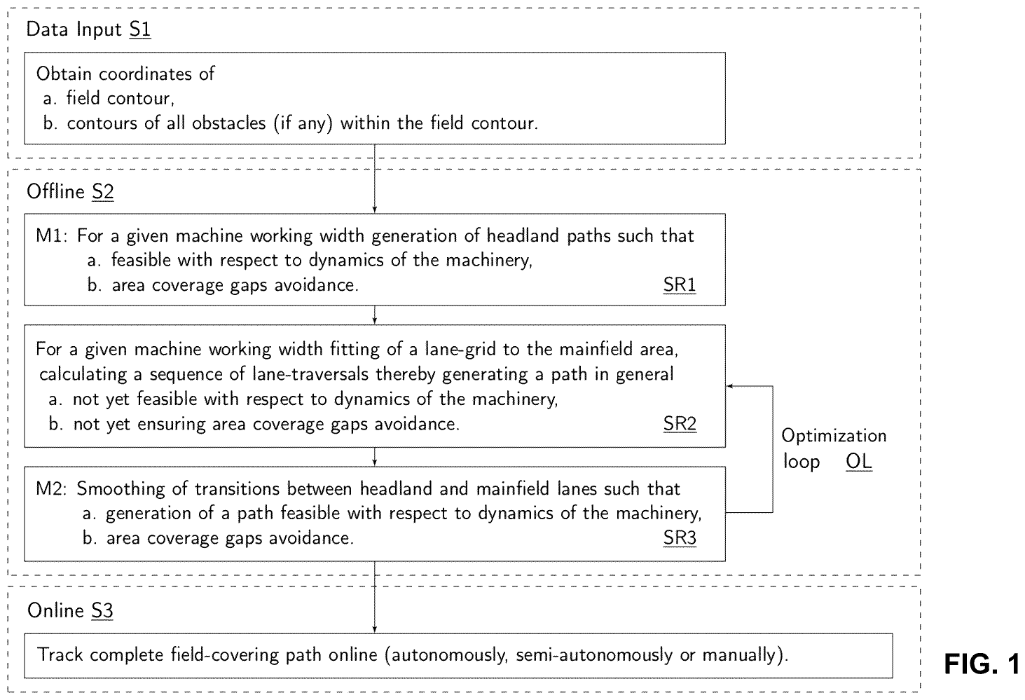

The FIGS. 1 to 14 show the invention. Same elements are marked with the same reference numbers.

### DESCRIPTION OF PREFERRED EMBODIMENTS

FIG. 1 displays a block diagram for the flow of actions comprising three main steps performed by the inventive method. The three main steps S1, S2, S3 follow each other.

The first step S1 is a data input comprising field contour. If any obstacles such as tree islands, ponds, power pole masts, and so forth are present within the field area, the first step S1 also comprises data input of obstacle area contours coordinates.

The second step S2 is offline computation generating an optimized field coverage path plan feasible with respect to dynamics of the machinery and minimizing area coverage gaps.

The third step S3 is online tracking of a complete field coverage path plan. Tracking can be performed either autonomously, semi-autonomously or manually by a human-being steering the machinery operating in the agricultural field or work area.

Dynamics of the machinery are described mathematically in form of a system of nonlinear differential equations. Their selection is preferably a user-choice trading off mathematical complexity and accuracy in their mathematical modeling of the machinery's mobility in the real world.

Area coverage refers to any process in which the working area is covered by a machinery for a specific purpose. Within an agricultural context machinery may for example be a tractor or harvester. The specific purpose is for example spraying, mowing, fertilizing, seeding, harvesting and so forth for a given working width.

Offline computation step S2 is divided into a first, a second and a third subroutine SR1, SR2 and SR3. The second and third subroutine, SR2 and SR3, are further embedded within an optimization loop and repeated iteratively to optimize a specific optimization criterion OL.

The first subroutine SR1 is abbreviated as Module M1. This first subroutine SR1 comprises for a working width of the machinery the generation of one or multiple precision headland paths that are (i) feasible with respect to dynamics of the machinery and (ii) minimize area coverage gaps. Headland path generation is applicable to both the field contour as well as the contours of any obstacles present within the field area. Obstacle headland paths are generated by making a copy of the contour of any obstacle and geometrically translating this copy in parallel by a fraction of the working width away from the obstacle interior, thereby obtaining a corrected eroded area and an eroded obstacle contour of any obstacle being present within the area and performing subroutine SR1 for each of the eroded obstacle contours, thereby generating an obstacle headland path for each obstacle being present within the area and the path being feasible with respect to dynamics of the machinery and minimizing area coverage gaps.

The third subroutine SR3 is abbreviated as Module M2. The third subroutine SR3 comprises the smoothing of transitions between any combination of headland path and mainfield lanes, e.g., transitions between headland path and mainfield lanes, between mainfield lanes and headland path, and between pairs of mainfield lanes, such that the resulting paths are (i) feasible with respect to dynamics of the machinery and (ii) minimize area coverage gaps.

Modules M1 and M2 can be considered as subroutines refining the solution of the second subroutine SR2 such that resulting paths account (i) for feasibility with respect to dynamics of the machinery while (ii) minimizing area coverage gaps.

For example, for computational efficiency or generality, a path plan may first be computed according to the second subroutine SR2 assuming only a working width as input parameter and not yet specifying dynamics of the machinery, fitting a lane-grid to the mainfield area, and calculating a sequence of lane-traversals to generate a field coverage path plan, but without accounting yet for feasibility of the resulting path plan with respect to the dynamics and area coverage gap avoidance. Then, an extension by Modules M1 and M2 within the framework of the first subroutine S2 can refine the path plan such that the resulting path plan is (i) feasible with respect to dynamics of the machinery and (ii) minimizing area coverage gaps.

When further iterating the second and third subroutines SR2 and SR3 according to a desired optimization criterion in an optimization loop OL, optimal path planning results can be attained.

A desired optimization criterion can represent at least one of the following:
minimization of total field coverage pathlength, minimization of accumulated length of mainfield lanes, minimization of accumulated turning for field coverage, minimization of accumulated turning when traversing between mainfield lanes and headland path, minimization of maximal turning when traversing between mainfield lanes and headland path, minimization of accumulated absolute vehicle roll angles above a user-defined threshold resulting from field slopes in hilly terrain along mainfield lanes, minimization of maximal absolute vehicle roll angles resulting from field slopes in hilly terrain along mainfield lanes, avoidance of absolute vehicle roll angles above a user-defined threshold resulting from field slopes in hilly terrain, connections to roads and logistical harvesting organization, minimization of completion time for field coverage, as well as a weighted trade-off between at least some of the aforementioned criteria.

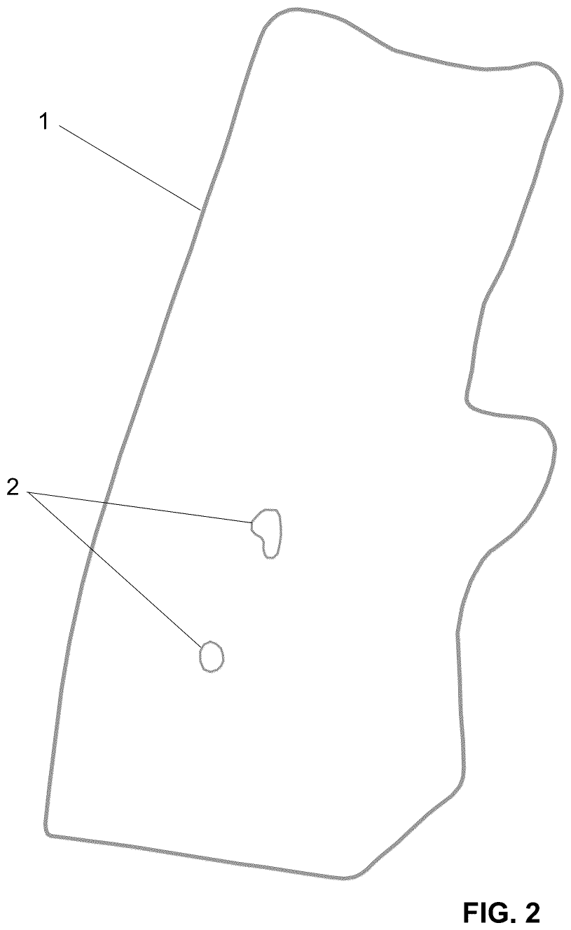

FIG. 2 illustrates an exemplary data input comprising a field contour 1 and two obstacle area contours 2.

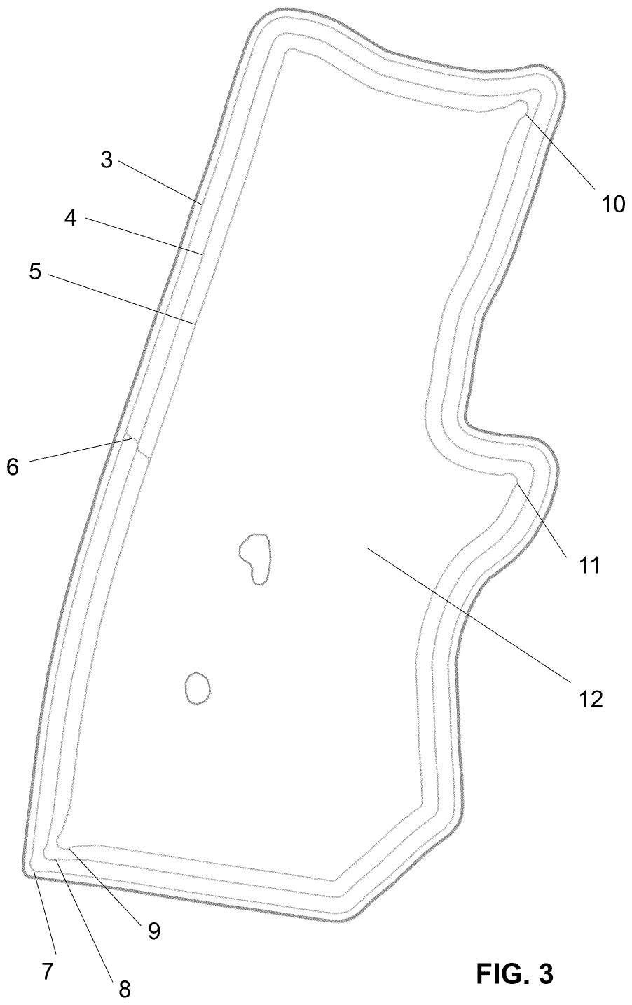

FIG. 3 illustrates the effect of Module M1 for the generation of headland paths. Module M1 comprises two hierarchical steps, whereby both are applied for the generation of each headland path. In the first hierarchical step, a headland path is generated by an erosion operation (mathematical morphological operation) for a working width. In the second hierarchical step, the headland path is refined and modified to account for (i) feasibility of the path with respect to dynamics of the machinery and (ii) area coverage gap avoidance. The headland path resulting from the second hierarchical step of Module M1 then serves as reference for the generation of a next headland path following the same procedure and so forth, until a desired number of headland paths is generated. In the following, both these hierarchical steps of Module M1 are discussed in more detail.

In the first hierarchical step of Module M1, by copying the field contour 1 and applying an erosion operation (mathematical morphological operation) for a working width, an eroded working area smaller than the working area and a corresponding eroded working area contour are obtained. This eroded working area contour is called headland path 3, see FIG. 3.

The erosion operation generates a headland path according to the first hierarchical step of Module M1. The path (i) does not guarantee feasibility with respect to dynamics of the machinery, and (ii) does in general not ensure area coverage gap avoidance.

In the second hierarchical step of Module M1, as input a mathematical description in form of a system of nonlinear differential equations modeling the dynamics of the machinery and its mobility inside the work area is assumed. The headland path is modified to account for feasibility of the path with respect to dynamics of the machinery and to minimize area coverage gaps. Therefore, (i) segments along the headland path are identified which are not feasible with respect to dynamics of the machinery, for example, with limited turning radius and similar constraints, or whose traversal would result in area coverage gaps occurring especially for highly curved field area contours. Then, (ii) spatial waypoint coordinates along the segments are modified in a manner, such that the area coverage gaps are corrected, for example by constructing a piecewise affine or polynomial envelope function (mathematical bounding function). Furthermore, (iii) the envelope function is used as a constraint in an optimization problem. The optimization problem is formulated after a special transformation of the mathematical description of the dynamics of the machinery from a time domain into a spatial domain. This special transformation from a time domain into a spatial domain is described in detail further below. The mathematical description of the dynamics of the machinery in the spatial domain is added as constraints to aforementioned optimization problem. As a result of this optimization problem formulation method the original objective of generating a headland path feasible with respect to dynamics of the machinery and area coverage gaps avoidance is addressed. A section of this headland path obtained by the inventive method is marked with reference number 7 in FIG. 3.

After the solution of aforementioned optimization problem, the corresponding modified headland path is constructed, which can then serve as the reference for the generation of a next headland path.

Thus, the erosion and refinement operation of the two hierarchical steps of Module M1 can be repeated iteratively and multiple times to generate multiple headland paths, see reference numbers 3, 4 and 5 in FIG. 3, and in particular the critical path segments 8, 9, 10 and 11 that require significant steering. Headland paths can be connected by transition paths, see reference number 6 in FIG. 3. The headland area is typically used for turning and usually planted in another direction than the mainfield area 12, which is the eroded working area bounded by the innermost headland path.

The insight of the usefulness of the special transformation of the mathematical description of the dynamics of the machinery from a time domain into a spatial domain for the achievement of high-precision path plans in the area coverage context is a central step of this invention and therefore discussed in more detail next. The fact that constraints can be formulated in the spatial domain permits generation of geographic high-precision paths.

For the aforementioned formulation of an optimization problem a transformation of the dynamics of the machinery from a time domain into a spatial domain is applied. This implies replacing time with a spatial coordinate along a path as the dependent variable and transforming the differential equations for the dynamics of the machinery from a time domain into a spatial domain. The transformation entails introducing a new set of variables describing the dynamics of the machinery in a path-aligned coordinate system instead of a global coordinate system with latitude and longitude (or their equivalent in the Universal Transverse Mercator (UTM) coordinate system in order to calculate in metric units) describing position coordinates.

In detail, denoting N geographic path coordinates as {xᵢ,yᵢ} for i=0, . . . , N (e.g., representing position coordinates in the UTM-coordinate system), they are transformed to {sᵢ, ρ_{s,i}, ψ_{s,i}, \dot{ψ}_{s,i}} for i=0, . . . , N, denoting the spatial coordinates along the path, the radius of curvature, heading and change of heading along that path, respecitvely, and where the dot represents the derivative with respect to time. Instead of expressing machinery position coordinates in a global coordinate system spanned by {x,y}, the machinery can now be expressed in a path-aligned coordinate frame {e_{ψ,i}, e_{y,i}} for i=0, . . . , N, denoting the deviation of the machinery heading and lateral deviation of the machinery with respect to the path. The change of the spatial coordinate along the path can be expressed as the differential equation, \dot{s}(t)=ρₛ(s(t))·\dot{ψ}ₛ(s(t)) for time t≥0. By geometric arguments, for the velocity of the machinery projected along the path, which shall be denoted by νₛ(s(t)), it holds νₛ(s(t))=(ρₛ(s(t))−e_{y}(s(t)))·\dot{ψ}ₛ(s(t)). Combining the two equations and further partitioning the projected velocity into a path-aligned and a path-orthogonal velocity component, which shall be denoted by ν_{ξ}(s(t)) and ν_{η}(s(t)), the following equation is derived, \dot{s}(t)=ρₛ(s(t))·(ν_{ξ}(s(t))·cos (e_{ψ}(s(t)))−ν_{η}(s(t))·sin (e_{ψ}(s(t))))/(ρₛ(s(t))−e_{y}(s(t))). Denoting machinery state dynamics by ż(t)=f(z (t), u(t)) for general machinery state z(t) and control variables u(t), then (i) by transformation of machinery location into a path-aligned coordinate system, which shall be denoted by żᵣ(s(t))=f(zᵣ(s(t)), u(t)), and (ii) elimination of time as the dependent variable and replacing it with space along the path as the dependent variable through the elementwise transformation z′ₛ(s)=żᵣ(s(t))/\dot{s}(t), dynamics of the machinery in the space domain are obtained, which shall be denoted as z′ₛ(s)=fₛ(zₛ(s), uₛ(s)), where the apostrophe/inverted comma now represents the derivative with respect to space. Then, for the path segment for which a path refinement is demanded such that the area coverage gap can be corrected a mathematical optimization problem can be formulated, in general form, {minimize g(zₛ(s), uₛ(s)) such that z′ₛ(s)=fₛ(zₛ(s), uₛ(s)) and hᵢ(zₛ(s), uₛ(s))≤0 for i=0, . . . , H, s∈[0, S]}, where

$$g ( {z}_{s} ( s ) , {u}_{s} ( s ) ) : {R}^{{n}_{{z}_{s}} + {n}_{{u}_{s}}} \to R$$

denotes the objective function describing any desired performance metric (e.g. seeking minimal deviation from the path) with state and control vector dimensions

$${n}_{{z}_{s}} > 0 and {n}_{{u}_{s}} > 0 and {h}_{i} ( {z}_{s} ( s ) , {u}_{s} ( s ) ) : {R}^{{n}_{{z}_{s}} + {n}_{{u}_{s}}} \to R ,$$

for i=0, . . . , H, denoting H constraint functions. While in general arbitrary many constraint functions are possible, and typically designed based on heuristics with the purpose of shaping the solution with a desired result in mind, according to the method of this invention the set of constraint functions preferably includes the condition e_{y,s}(s)≤0, or altenratively, for generality and path shaping purpose,

$${e}_{y , s} ( s ) - {e}_{y , s}^{ref} ( s ) \leq 0$$

for desired reference shaping path

$${e}_{y , s}^{ref} ( s ) ∈ R .$$

The reason for the proposal of this inequality constraint is to be understood in connection with the first hierarchical step mentioned above and the path correction. As discussed above, the path must be constructed as an envelope function such that area coverage gaps are avoided. This path correction step does standalone and per se not yet guarantee feasibility with respect to dynamics of the machinery. However, remedy can be provided through the formulation of above-mentioned general optimization problem in the spatial domain which (i) includes dynamics of the machinery as equality constraints, and (ii) the path envelope is accounted for via aforementioned inequality constraints. As a result, a path both feasible with respect to dynamics of the machinery and also minimizing area coverage gaps can be generated. In practice, inequality constraints can also be relaxed by the introduction of slack variables or the terms on the left-hand side of the inequality constraints can be included into the objective function via Lagrangian multipliers (mathematical optimization concept). Above general optimization problem formulation assumes continuous spatial coordinate s≥0. In practice, a linearization and discretization around the path may be carried out to make the optimization problem more computationally tractable. After solving the optimization problem, the resulting path is obtained in the path-aligned coordinate system. After a coordinate transformation back to the global coordinate system, such as the UTM-coordinate system (to calculate in metric units), the path plan as a sequence of geographic waypoint coordinates is obtained, (i) accounting for dynamics of the machinery and (ii) minimizing area coverage gaps.

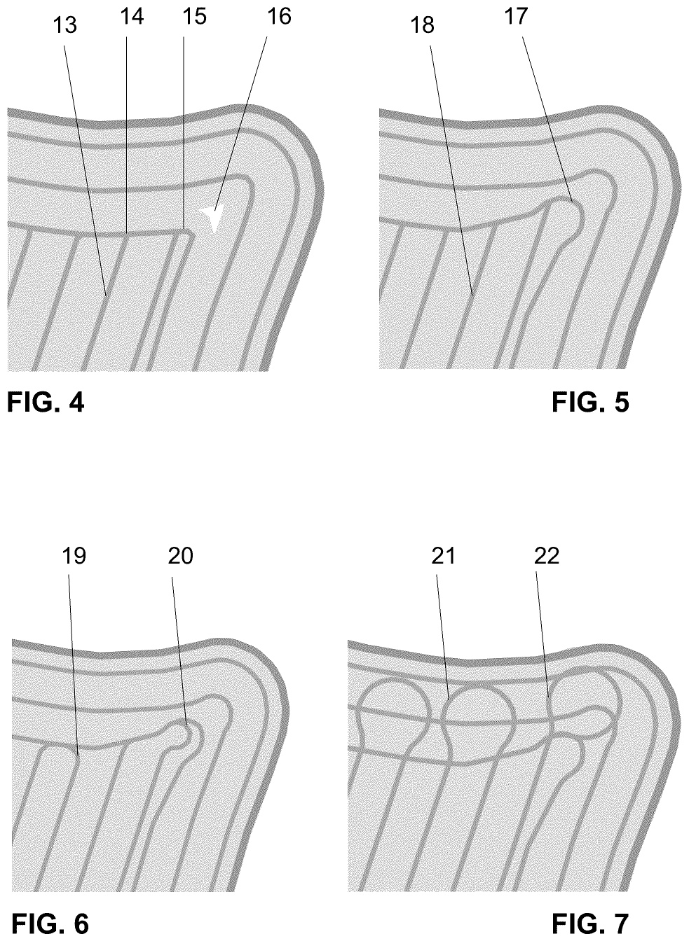

FIG. 4 illustrates an area coverage gap 16 and a headland path segment 15 not feasible with respect to dynamics of the machinery for a typical nonholonomic (mathematical system characteristics) machinery operating with a limited turning radius. Such paths result when generating headland paths without explicitly accounting for dynamics of the machinery and area coverage gap avoidance. FIG. 4 further illustrates an exemplary mainfield lane 13 and a transition between mainfield lane and headland path at point 14 that is not feasible with respect to dynamics of the machinery when accounting for a typical nonholonomic machinery operating with a limited turning radius.

FIG. 5 illustrates how the issue of the area coverage gap 16 in FIG. 4 can be solved according to Module M1 in block diagram of FIG. 1. The previous area coverage gap is now avoided while the modified headland path 17 is simultaneously feasible with respect to dynamics of the machinery with a limited turning radius. FIG. 5 further illustrates that as a result of the headland path modification the design of the lane-grid and coordinates of mainfield lanes are also affected, compare the path 18 in FIG. 5 and path 13 in FIG. 4. This is in accordance with the sequential flow of actions SR1 to SR3 in the block diagram of FIG. 1.

FIG. 6 illustrates a transition between headland path and mainfield lane accounting for dynamics of the machinery according to Module M2 and the flow of actions in FIG. 1, resulting in a smooth transition 19, whereby in this illustration, dynamics of the machinery with a turning radius less than half the working width are assumed. A second exemplary transition 20 between headland path and mainfield lane is illustrated in FIG. 6 as well.

FIG. 7 illustrates exemplary transitions 21 and 22 between headland path and mainfield lanes accounting for dynamics of the machinery according to Module M2 and the flow of actions in FIG. 1, whereby in this illustration dynamics of the machinery with a larger turning radius more than half the working width are assumed, which results in the specific transition as shown, while ensuring area coverage gap avoidance. In the following, Module M2 is discussed in detail.

Module M2 addresses the generation of precision paths for the transitions between headland path and mainfield lanes, between mainfield lanes and headland path, and between pairs of mainfield lanes. Module M2 comprises two hierarchical steps. In the first hierarchical step, a transition path is generated. In the second hierarchical step, the transition path is modified to account for (i) feasibility of the path with respect to dynamics of the machinery, and (ii) area coverage gap avoidance. In the following, both these hierarchical steps of Module M2 are discussed in more detail.

The first hierarchical step of Module M2 comprises the steps of (i) taking as input a path plan consisting of a sequence of transitions between headland path and mainfield lanes, between mainfield lanes and headland path or between pairs of mainfield lanes, and (ii) modifying spatial waypoint coordinates along the transitions through their replacement with suitably fitted path segments (e.g., minimally deviating from the original transition) derived from Dubins and Reeds-Shepp path planning. These modifications in general do not yet guarantee feasibility with respect to dynamics of the machinery. There is no guarantee that the segments can actually be traversed, for example, by an autonomous tractor or harvester, since Dubins and Reeds-Shepp paths are derived from simplified vehicle dynamics that may not represent the actual dynamics of the machinery. Feasibility with respect to a mathematical description of desired dynamics of the machinery is addressed in the second hierarchical step of Module M2. Both steps are discussed in more detail next.

For the path modification it is differentiated between transitions
(i) from a mainfield lane to a headland path,
(ii) from a headland path to a mainfield lane,
(iii) from a headland path to another headland path,
(iv) between two different mainfield lanes when the turning radius of a typical nonholonomic machinery operating in the work area is larger than half the working width of the machinery such that especially significant steering is required, and finally
(v) special transitions.

Special transitions are for example transitions between two different headland paths, wherein this aspect is only relevant if there are multiple headland paths in the field. Other examples are transitions onto the field and the final transition to the field exit after completion of field work.

Then, based on aforementioned transition types a Dubins path is fitted to smooth spatial waypoint coordinates along the transitions. A Dubins path provides the shortest path between two coordinates and heading directions for a forward-moving vehicle with a specific turning radius. A shortest path is preferably desired since it minimizes compacted tractor trace area and thereby simultaneously maximizes residual field area that can be used for growing of agricultural crops.

However, a Dubins path, which is composed entirely of no more than three circular arcs of minimum turning radius or straight lines, is derived based on a simplified mathematical model of a vehicle. In detail, the nonlinear differential equations describing the dynamics of location coordinates and heading direction in the two-dimensional plane are {\dot{x}(t)=cos (θ(t)), \dot{γ}(t)=sin (θ(t)), \dot{θ}(t)=α(t) with α(t) ∈[−1/Rₘᵢₙ, 1/Rₘᵢₙ] and time t≥0}, where Rₘᵢₙ>0 denotes the minimum turning radius. This simplified mathematical model, in general, does not accurately represent the dynamics of an agricultural machinery operating in a field which typically are more complex. Thus, in general the Dubins path does not guarantee feasibility with respect to actual dynamics of the machinery, which is required for high-precision path planning, especially for autonomous robots in agricultural applications.

Therefore, according to the method of this invention an additional path plan refinement is proposed. The second path modification takes as input (i) aforementioned path plan resulting from the Dubins path fitting step, and (ii) a mathematical description of desired dynamics of the machinery in form of a system of nonlinear differential equations. Then, to generate the second path modification such that the resulting path becomes feasible with respect to dynamics of the machinery, for the second hierarchical step of Module M2 the same mathematical method as in the second hierarchical step of Module M1 is applied.

Thus, first a transformation of the dynamics of the machinery from a time domain into a spatial domain is applied. This implies replacing time with a spatial coordinate along the transition path resulting from the first hierarchical step of Module M2 as the dependent variable and transforming the nonlinear differential equations for the dynamics of the machinery from a time domain into a spatial domain. The transformation entails introducing a new set of variables describing the dynamics of the machinery in a path-aligned coordinate system instead of a global coordinate system, e.g., the UTM-coordinate system. The same mathematical derivation for the transformation from a time domain into a spatial domain as described above for the discussion of Module M1 applies, and likewise the formulation of a corresponding optimization problem. After solving the optimization problem, a resulting path is obtained in the path-aligned coordinate system. After a coordinate transformation back to a global coordinate system, such as the UTM-coordinate system, the path plan as a sequence of geographic waypoint coordinates is obtained, (i) accounting for dynamics of the machinery and (ii) minimizing area coverage gaps.

The insight of the usefulness of using a hierarchical two-step framework in combination with a special coordinate transformation from a time domain into a spatial domain to formulate geographic high-precision constraints and the usefulness of this hierarchical two-step framework to address both objectives, the generation of headland paths as well as the generation of smooth transitions between headland path and mainfield lanes, whereby the first hierarchical step varies for the two objectives, is a central step of this invention.

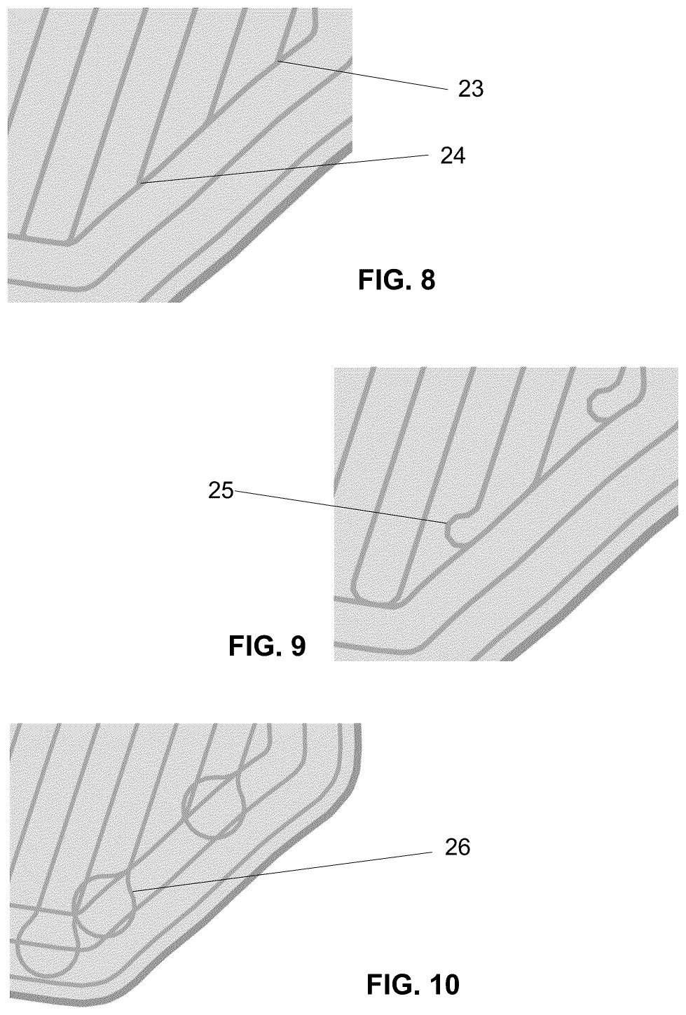

FIG. 8 illustrates transitions 23 and 24 between headland path and mainfield lanes that are not feasible with respect to dynamics of the machinery of typical nonholonomic vehicles with a limited turning radius.

FIG. 9 illustrates transition 25 when, in contrast to FIG. 8, now accounting for dynamics of the machinery resulting in a steering maneuver, whereby in this illustration dynamics of the machinery with a turning radius less than half the working width are assumed. The specific path results according to Module M2 such that area coverage gaps are avoided.

FIG. 10 illustrates transition 26 when, in contrast to FIG. 8, now accounting for dynamics of the machinery resulting in a steering maneuver, whereby in this illustration dynamics of the machinery with a larger turning radius more than half the working width are assumed.

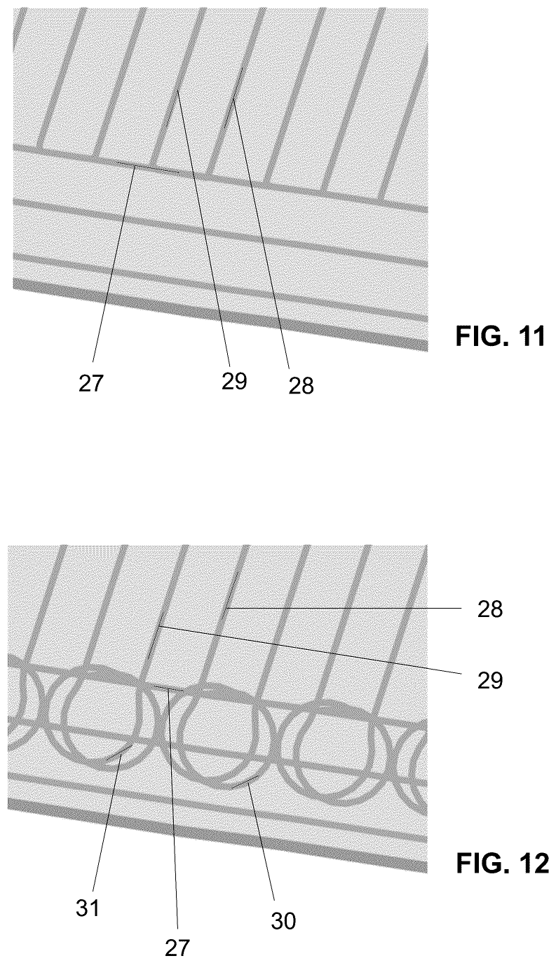

FIG. 11 illustrates transitions between mainfield lanes and headland path, in particular, a sequence of transitions from headland path 27 up to mainfield lane 28, before then returning back to the headland path via mainfield lane 29, when not yet accounting for dynamics of the machinery with a typically limited turning radius.

FIG. 12 illustrates the same transition as in FIG. 11 when now accounting for dynamics of the machinery resulting in a steering maneuver 30 and 31 according to Module M2, whereby in this illustration dynamics of the machinery with a larger turning radius more than half the working width are assumed. In detail, these particular steering maneuvers result as indicated ensuring area coverage gap avoidance and, since the headland path 27 according to FIG. 12 must be covered as part of a high-level field coverage path plan, in this specific case requiring in sequence the coverage of mainfield lanes 28 and 29.

The aforementioned two examples are given to underline the role of modules M1 and M2 in supporting a high-level path planner for field coverage and refining its path plan logic to achieve (i) feasibility with respect to dynamics of the machinery and (ii) minimization of area coverage gaps within the framework and block diagram for the flow of actions of FIG. 1.

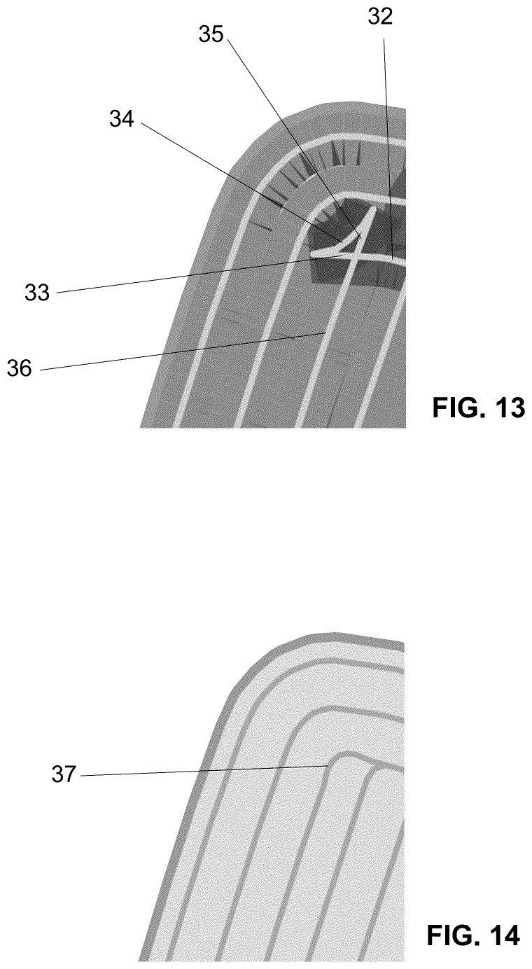

FIG. 13 illustrates the usage of a Reeds-Shepp path, which involves both forward motion, 33 and 35, and backward motion 34, for the transition from headland path segment 32 to headland path segment 36.

A Reeds-Shepp path differs from a Dubins path in that travel in the reverse direction is also allowed. While for a Dubins path only forward-motion applies, a Reeds-Shepp path permits combinations of forward- and backward-motion. Thus, Reeds-Shepp paths are a generalization of Dubins paths. Reeds-Shepp paths can be refined to account for dynamics of the machinery just as described above. Regarding an implementation detail, to make the computational problem more tractable forward- and backward-motion segments can be treated separately and refined separately.

Reeds-Shepp paths may be of interest particularly along tight turns along headland paths and to avoid area coverage gaps along headland paths, for example, for field mowing or harvesting applications. However, they can also be replaced by Module M1 for area coverage gaps avoidance as described above. This can have two core benefits: forward motion only and typically less pathlength, which consequently also implies less undesired compacted area from tractor traces, and thereby simultaneously maximizes residual field area that can be used for growing of agricultural crops, and less travel time or working time in the field by avoiding combined backward- and forward-motion.

FIG. 14 illustrates a section of the resulting path 37 when replacing the Reeds-Shepp path segment of FIG. 13 with an alternative path resulting from the application of Module M1 of this invention when accounting for dynamics of the machinery, simultaneously targeting area coverage gap avoidance and desiring forward motion only to save pathlength. As shown, pathlength in FIG. 14 is much shorter in contrast to the Reeds-Shepp path segment of FIG. 13, while not compromising area coverage gap avoidance.

1. A computer-implemented method for automatically path planning for optimizing a path of a machinery moving in an area, the method comprising the steps of
considering at least the following parameters:
coordinates of an area contour of the area in a global coordinate system,
a working width of the machinery operating in the area,
a mathematical description of dynamics of the machinery operating in the area in form of a system of nonlinear differential equations,
making a copy of the area contour and geometrically translating this copy in parallel by a fraction of the working width to an interior of the area, thereby obtaining an eroded area being smaller or equal than the area and an eroded area contour of the eroded area, the eroded area contour being denoted as a headland path,
determining first segments along the headland path which are not feasible to be traversed by the machinery due to the dynamics of the machinery or whose traversal would result in area coverage gaps for the working width of the machinery,
modifying the first segments such that their traversals become feasible with respect to dynamics of the machinery and such that their traversals minimize area coverage gaps, thereby using a first mathematical algorithm,
wherein the first mathematical algorithm comprises two hierarchical steps for handling each of the first segments,
(i) first, creating a first modification by modifying spatial waypoint coordinates along each of the first segments by heuristics including selection of interpolation and discretization spacing, such that the area coverage gaps are minimized or avoided, but a first resulting path is not yet feasible with respect to dynamics of the machinery,
(ii) second, creating a second modification by applying a transformation of the system of nonlinear differential equations describing the dynamics of the machinery from a time domain into a spatial domain, wherein, in the system of nonlinear differential equations, time as a dependent variable is replaced by space as the dependent variable along the first resulting path of step (i), and introducing a new set of variables in a path-aligned coordinate system instead of the global coordinate system, formulating a first mathematical optimization problem with a set of inequality constraints based on the path resulting from the previous step (i) such that the area coverage gaps are minimized or avoided, and with a set of equality constraints such that a second resulting path is made feasible with respect to the dynamics of the machinery, solving the first mathematical optimization problem and transforming a solution of the first mathematical optimization problem from the path-aligned coordinate system back to the global coordinate system, such that after the modification of all the first segments a modified headland path is generated that is feasible with respect to dynamics of the machinery and minimizes area coverage gaps.

2. The method of claim 1 wherein the method further comprises the steps of
selecting an orientation of straight lanes or a shape of freeform lanes within the area bounded by the modified headland path and thereby partitioning the eroded area into adjacent mainfield lanes,
intersecting the mainfield lanes with the modified headland path, thereby generating a lane-grid,
determining a sequence for the traversal of the mainfield lanes for area coverage, thereby generating a path plan for area coverage given by a sequence of position coordinates,
determining second segments along the path plan for area coverage which are not feasible to be traversed by the machinery due to the dynamics of the machinery or whose traversal would result in area coverage gaps, specifically, at transitions between headland path and mainfield lanes, between mainfield lanes and headland path, and between pairs of mainfield lanes,
modifying the second segments such that their traversals become feasible with respect to dynamics of the machinery and such that their traversals minimize area coverage gaps, thereby using a second mathematical algorithm,
wherein the second mathematical algorithm comprises two hierarchical steps for handling of each of the second segments,
(i) first, creating a first modification by modifying spatial waypoint coordinates along each of the second segments through their replacement with a suitably fitted path segment, preferably a Dubins or Reeds-Shepp path segment, such that the second resulting path is smoothed but in general not yet feasible with respect to dynamics of the machinery,
(ii) second, creating a second modification by applying a transformation of the system of nonlinear differential equations describing the dynamics of the machinery from a time domain into a spatial domain, wherein, in the system of nonlinear differential equations, time as the dependent variable is replaced by space as the dependent variable along the second resulting path of step (i) and introducing a new set of variables in a path-aligned coordinate system instead of the global coordinate system, formulating a second mathematical optimization problem with a set of inequality constraints based on the path resulting from the previous step (i) such that area coverage gaps are avoided, and with a set of equality constraints such that a second resulting path is made feasible with respect to the dynamics of the machinery, solving the second mathematical optimization problem and transforming a solution of the second mathematical optimization problem from the path-aligned coordinate system back to the global coordinate system, such that after the modification of all the second segments a modified path plan for area coverage is generated that is feasible with respect to dynamics of the machinery and minimizes area coverage gaps.

3. The method of claim 1 wherein a first cascade of headland paths are generated by conducting multiple times an erosion operation (mathematical morphological operation) for a given working width and a given contour of the field area, and wherein the first mathematical algorithm is iteratively applied to each of the first cascade of headland paths thereby generating multiple modified headland paths each being feasible with respect to dynamics of the machinery and minimizing area coverage gaps.

4. The method of claim 1 wherein the considered parameters additionally include coordinates of a contour of any obstacle being present within the area, wherein the obstacle is not to be passed by the moving machinery, and wherein the method comprises the further steps of:
making a copy of the contour of any obstacle and geometrically translating this copy in parallel by a fraction of the working width away from the obstacle interior, thereby obtaining a corrected eroded area and an eroded obstacle contour of any obstacle being present within the area and
performing the first mathematical algorithm for each of the eroded obstacle contours, thereby generating an obstacle headland path for each obstacle being present within the area and the path being feasible with respect to dynamics of the machinery and minimizing area coverage gaps.

5. The method of claim 4 wherein a second cascade of headland paths are generated by conducting multiple times an erosion operation for a given working width and a given contour of any obstacle present within the field area and wherein the first mathematical algorithm is iteratively applied to each of the second cascade of headland paths, thereby generating multiple obstacle headland paths each being feasible with respect to dynamics of the machinery and minimizing area coverage gaps.

6. The method of claim 2 wherein the method comprises the step of determining a sequence of mainfield lanes to generate a path plan for area coverage whose traversal does not yet account for feasibility with respect to the dynamics of the machinery and for area coverage gap avoidance, and performing the method within a global optimization scheme,
thereby generating an optimal path plan for area coverage that is feasible with respect to dynamics of the machinery, minimizing area coverage gaps and is optimized according to one of the criteria of: minimization of total field coverage pathlength, minimization of accumulated length of mainfield lanes, minimization of accumulated turning for field coverage, minimization of accumulated turning when traversing between mainfield lanes and headland path, minimization of maximal turning when traversing between mainfield lanes and headland path, minimization of accumulated absolute vehicle roll angles above a user-defined threshold resulting from field slopes in hilly terrain along mainfield lanes, minimization of maximal absolute vehicle roll angles resulting from field slopes in hilly terrain along mainfield lanes, avoidance of absolute vehicle roll angles above a user-defined threshold resulting from field slopes in hilly terrain, connections to roads and logistical harvesting organization, minimization of completion time for field coverage, as well as a weighted trade-off between at least some of the aforementioned criteria.

7. The method of claim 1 wherein the method provides as output at least a sequence of position coordinates, the sequence giving a path to be followed by the machinery.

8. A first software program product for performing the method of claim 1, the first software program product comprising an algorithm for computing a path plan feasible with respect to dynamics of the machinery and minimizing area coverage gaps.

9. A second software program product comprising stored data identifying a path based on position coordinates of a machinery according to the method of claim 1 wherein the second software program product gives guidance to the machinery and/or a user of the machinery in order to enable the machinery to follow the path by usage of information of at least one location sensor.

10. A device for performing the method according to claim 1 wherein the device comprises input means for providing parameters, means for reading of geographic location measurements returned from a location sensor and wherein the device comprises
display means for displaying data enabling a machinery and/or a user of the machinery to follow a path and/or
output means for delivering data enabling the machinery and/or the user of the machinery to follow the path.

11. A computer-implemented method for automatically path planning for optimizing a path of a machinery moving in an area, the method comprising the steps of
considering at least the following parameters:
coordinates of an area contour of the area in a global coordinate system,
a working width of the machinery operating in the area,
a mathematical description of dynamics of the machinery operating in the area in form of a system of nonlinear differential equations,
making a copy of the area contour and geometrically translating this copy in parallel by a fraction of the working width to an interior of the area, thereby obtaining an eroded area being smaller or equal than the area and an eroded area contour of the eroded area, the eroded area contour being denoted as a headland path,
selecting an orientation of straight lanes or a shape of freeform lanes within the area bounded by the modified headland path and thereby partitioning the eroded area into adjacent mainfield lanes,
intersecting the mainfield lanes with the headland path, thereby generating a lane-grid,
determining a sequence for the traversal of the mainfield lanes for area coverage, thereby generating a path plan for area coverage given by a sequence of position coordinates,
determining second segments along the path plan for area coverage which are not feasible to be traversed by the machinery due to the dynamics of the machinery or whose traversal would result in area coverage gaps, specifically, at transitions between headland path and mainfield lanes, between mainfield lanes and headland path, and between pairs of mainfield lanes,
modifying the second segments such that their traversals become feasible with respect to dynamics of the machinery and such that their traversals minimize area coverage gaps, thereby using a second mathematical algorithm,
wherein the second mathematical algorithm comprises two hierarchical steps for handling of each of the second segments,
(i) first, creating a first modification by modifying spatial waypoint coordinates along each of the second segments through their replacement with a suitably fitted path segment, preferably a Dubins or Reeds-Shepp path segment, such that the second resulting path is smoothed but in general not yet feasible with respect to dynamics of the machinery,
(ii) second, creating a second modification by applying a transformation of the system of nonlinear differential equations describing the dynamics of the machinery from a time domain into a spatial domain, wherein, in the system of nonlinear differential equations, time as a dependent variable is replaced by space as the dependent variable along the second resulting path of step (i) replacing time as a dependent variable in the system of nonlinear differential equations and introducing a new set of variables in a path-aligned coordinate system instead of the global coordinate system, formulating a second mathematical optimization problem with a set of inequality constraints based on the path resulting from the previous step (i) such that area coverage gaps are avoided, and with a set of equality constraints such that a second resulting path is made feasible with respect to the dynamics of the machinery, solving the second mathematical optimization problem and transforming a solution of the second mathematical optimization problem from the path-aligned coordinate system back to the global coordinate system, such that after the modification of all the second segments a modified path plan for area coverage is generated that is feasible with respect to dynamics of the machinery and minimizes area coverage gaps.

12. The method of claim 11 wherein the method comprises the step of determining a sequence of mainfield lanes to generate a path plan for area coverage whose traversal does not yet account for feasibility with respect to the dynamics of the machinery and for area coverage gap avoidance, and performing the method within a global optimization scheme,
thereby generating an optimal path plan for area coverage that is feasible with respect to dynamics of the machinery, minimizing area coverage gaps and is optimized according to one of the criteria of: minimization of total field coverage pathlength, minimization of accumulated length of mainfield lanes, minimization of accumulated turning for field coverage, minimization of accumulated turning when traversing between mainfield lanes and headland path, minimization of maximal turning when traversing between mainfield lanes and headland path, minimization of accumulated absolute vehicle roll angles above a user-defined threshold resulting from field slopes in hilly terrain along mainfield lanes, minimization of maximal absolute vehicle roll angles resulting from field slopes in hilly terrain along mainfield lanes, avoidance of absolute vehicle roll angles above a user-defined threshold resulting from field slopes in hilly terrain, connections to roads and logistical harvesting organization, minimization of completion time for field coverage, as well as a weighted trade-off between at least some of the aforementioned criteria.

13. The method of claim 11 wherein the method provides as output at least a sequence of position coordinates, the sequence giving a path to be followed by the machinery.

14. A first software program product for performing the method of claim 11, the first software program comprising an algorithm for computing a path plan feasible with respect to dynamics of the machinery and minimizing area coverage gaps.

15. A second software program product comprising stored data identifying a path based on position coordinates of a machinery according to the method of claim 11 wherein the second software program gives guidance to the machinery and/or a user of the machinery in order to enable the machinery to follow the path by usage of information of at least one location sensor.

16. A device for performing the method according to claim 11 wherein the device comprises input means for providing parameters, means for reading of geographic location measurements returned from a location sensor and wherein the device comprises
display means for displaying data enabling a machinery and/or a user of the machinery to follow a path and/or
output means for delivering data enabling the machinery and/or the user of the machinery to follow the path.
